(19) United States
(12) Patent Application Publication
(10) Pub. No.: US 2014/0336924 A1
(43) Pub. Date: Nov. 13, 2014

(54) NAVIGATOR CAPABLE OF PROVIDING REAL-TIME TRAFFIC INFORMATION

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/180,279

(22) Filed: Feb. 13, 2014

(30) Foreign Application Priority Data
May 9, 2013 (TW) 102116562

(51) Int. Cl. G01C 21/34

(52) U.S. Cl. CPC G01C 21/3492
USPC 701/423

(57) ABSTRACT

A navigator includes a storing module storing a map, a navigating module for obtaining a present location via a navigating network, an interface connecting the navigator to a portable communication terminal, a user interface for receiving user input, and a processing module. The portable communication terminal communicates with a service and/or information center that provides real-time traffic information via a wireless communication network. The processing module processes the user input and the map to determine routes from a present location to a destination, processes the map and the real-time traffic information related to the routes, and displays the routes with the real-time traffic information on the user interface.

### BACKGROUND

1. Technical Field

The present disclosure relates to navigation technologies, and particularly to a navigator capable of providing real-time traffic information.

2. Description of Related Art

To provide real-time traffic information, navigators are equipped with a communication module to communicate with and access the real-time traffic information from an available service and/or information center. However, the communication module greatly increases a cost of the navigator.

Therefore, it is desirable to provide a navigator that can overcome the above-mentioned problem.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a schematic view of an embodiment of a navigation system.

FIG. 2 is a functional block diagram of the navigation system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the drawings.

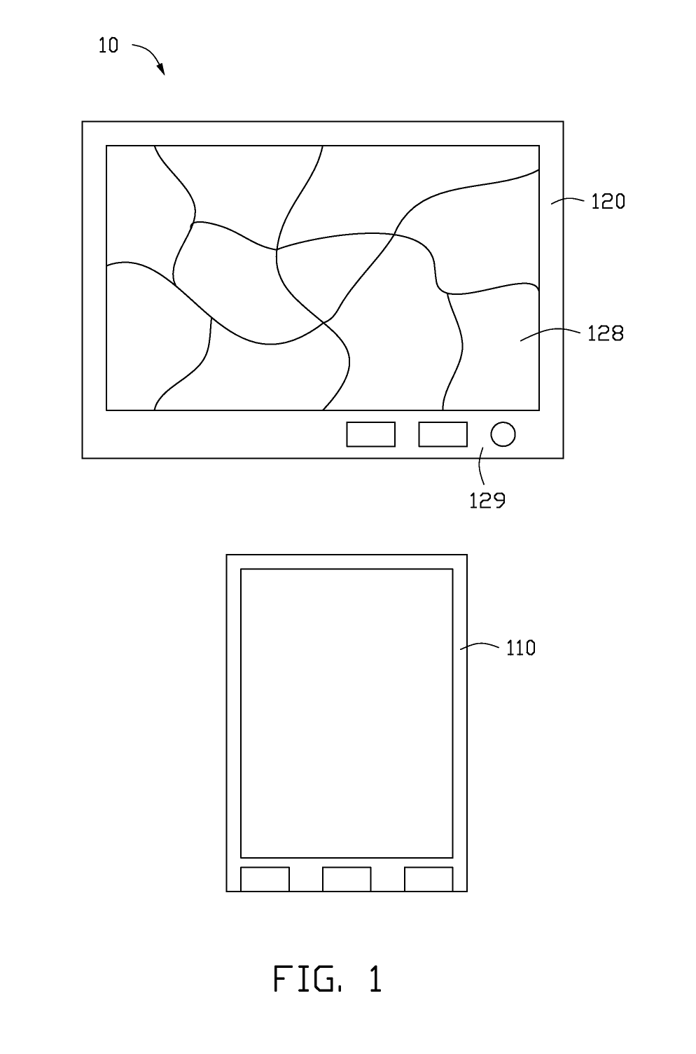

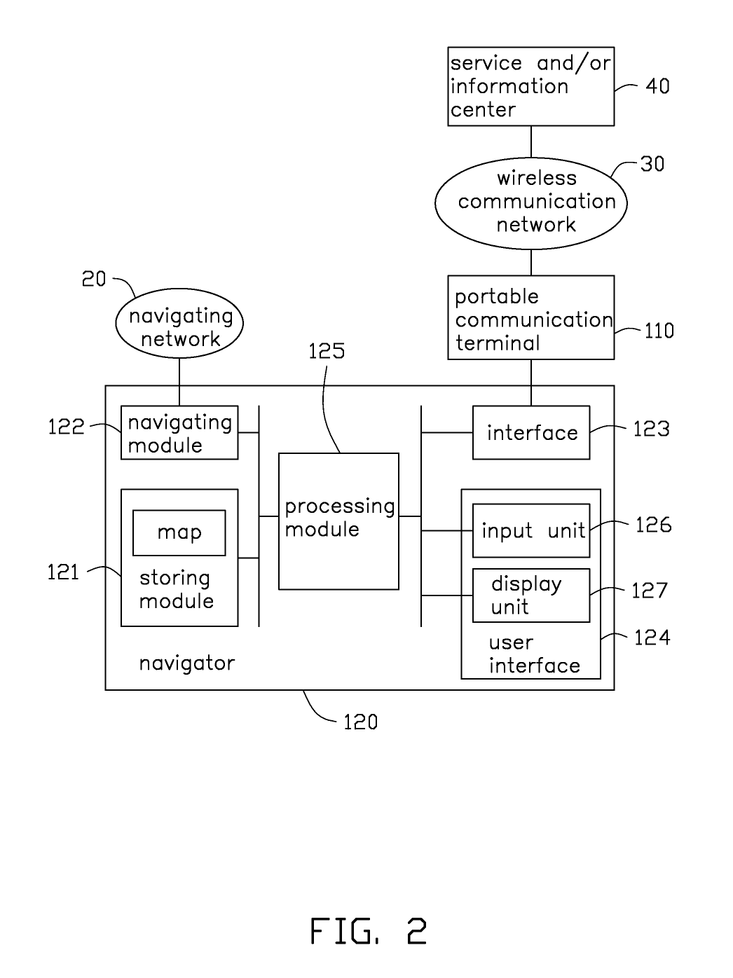

FIGS. 1 and 2 show an embodiment of a navigation system 10. The navigation system 10 includes a portable communication terminal 110 and a navigator 120. The navigator 120 connects to the portable communication terminal 110 to provide real-time traffic information.

The portable communication terminal 110 can be, but is not limited to, a mobile phone, a personal digital assistant, or any suitable portable electronic device that can communicate with an available service and/or information center 40. The service and/or information center 40 provides the real-time traffic information via a wireless communication network 30, such as a general packet radio service (GPRS) or a wideband code division multiple access (WCDMA) network.

Because the navigator 120 utilizes the portable communication terminal 110 as an expandable device to acquire the real-time traffic information, an additional communication module equipped therein is omitted. As such, a cost of the navigator 120 is reduced.

The navigator 120 includes a storing module 121, a navigating module 122, an interface 123, a user interface 124, and a processing module 125.

The storing module 121 can be a flash memory, such as a secure digital card, and stores a map. The map can be downloaded and updated from the service and/or information center 40 in real- time. Alternatively, the map can be pre-stored.

The navigating module 122 obtains a present location via a navigating network 20. In this embodiment, the navigating module 122 includes a global positioning system (GPS) sensor (not shown), and the navigating network 20 is GPS-based.

The interface 123 connects the navigator 120 to the portable communication terminal 110. The interface 123 can be a universal serial bus (USB), infrared, or BLUETOOTH interface.

The user interface 124 includes an input unit 126 configured for receiving user input, and a display unit 127 configured for displaying information. In this embodiment, the input unit 126 includes a touch panel 128 and a keyboard 129, and the touch panel 128 serves as the display unit 127. The user input can include destinations and selection of routes.

The processing module 125 processes the user input and the map to determine a plurality of routes from the present location to the destination. The routes can include a shortest route, a highway route, and a fastest route. The processing module 125 also processes the map and the real-time traffic information related to the routes and displays the routes with the real-time traffic information on the display unit 127 for assisting in the selection of the routes. For example, a congested route is displayed as red, a slower route is displayed as yellow, and an unimpeded route is displayed as green.

Instead of employing an additional communication module, the navigator 120 accesses the real-time traffic information utilizing the portable communication terminal 110 via the interface 123. As such, a cost of the navigator 120 is reduced.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A navigator, comprising:
a storing module storing a map;
a navigating module configured for obtaining a present location via a navigating network;
an interface for connecting the navigator with a portable communication terminal, the portable communication terminal communicating with a service or information center that provides real-time traffic information via a wireless communication network to access the real-time traffic information;
a user interface configured for receiving user input comprising a destination and selections of routes; and
a processing module configured for processing the user input and the map to determine a plurality of routes from the present location to the destination, processing the map and the real-time traffic information related to the candidate routes, and driving the user interface to display the routes with the real-time traffic information.

2. The navigator of claim 1, wherein the interface is selected from the group consisting of a universal serial bus, a infrared, and a BLUETOOTH interfaces.
